(19) United States
(12) Patent Application Publication
(10) Pub. No.: US 2017/0300422 A1
(43) Pub. Date: Oct. 19, 2017

(54) MEMORY DEVICE WITH DIRECT READ ACCESS

(71) Applicant: Micron Technology, Inc., Boise, ID (US)

(72) Inventor: Zoltan Szubbocsev, Haimhausen (DE)

(21) Appl. No.: 15/099,389

(22) Filed: Apr. 14, 2016

(51) Int. Cl. G06F 12/10

(52) U.S. Cl. CPC G06F 12/10; G06F 2212/7201

(57) ABSTRACT

Several embodiments of memory devices with direct read access are described herein. In one embodiment, a memory device includes a controller operably coupled a plurality of memory regions forming a memory. The controller is configured to store a first mapping table at the memory device and also to provide the first mapping table to a host device for storage at the host device as a second mapping table. The controller is further configured to receive a direct read request sent from the host device. The read request includes a memory address that the host device has selected from the second memory table stored at the host device. In response to the direct read request, the controller identifies a memory region of the memory based on the selected memory address in the read request and without using the first mapping table stored at the memory device.

### TECHNICAL FIELD

The disclosed embodiments relate to memory devices, and, in particular, to memory devices that enable a host device to locally store and directly access an address mapping table.

### BACKGROUND

Memory devices can employ flash media to persistently store large amounts of data for a host device, such as a mobile device, a personal computer, or a server. Flash media includes “NOR flash” and “NAND flash” media. NAND-based media is typically favored for bulk data storage because it has a higher storage capacity, lower cost, and faster write speed than NOR media. NAND-based media, however, requires a serial interface, which significantly increases the amount of time it takes for a memory controller to read out the contents of the memory to a host device.

Solid state drives (SSDs) are memory devices that can include both NAND-based storage media and random access memory (RAM) media, such as dynamic random access memory (DRAM). The NAND-based media stores bulk data. The RAM media stores information that is frequently accessed by the controller during operation.

One type of information typically stored in RAM is an address mapping table. During a read operation, an SSD will access the mapping table to find the appropriate memory location from which content is to be read out from the NAND memory. The mapping table associates a native address of a memory region with a corresponding logical address implemented by the host device. In general, a host-device manufacturer will use its own unique logical block addressing (LBA) conventions. The host device will rely on the SSD controller to translate the logical addresses into native addresses (and vice versa) when reading from (and writing to) the NAND memory.

Some lower cost alternatives to traditional SSDs, such as universal flash storage (UFS) devices and embedded MultiMediaCards (eMMCs), omit RAM. In these devices, the mapping table is stored in the NAND media rather than in RAM. As a result, the memory device controller has to retrieve addressing information from the mapping table over the NAND interface (i.e., serially). This, in turn, reduces read speed because the controller frequently accesses the mapping during read operations.

### BRIEF DESCRIPTION OF THE DRAWINGS

FIG. 1 is a block diagram of a system having a memory device configured in accordance with an embodiment of the present technology

FIGS. 2A and 2B are message flow diagrams illustrating various data exchanges with a memory device in accordance with embodiments of the present technology.

FIGS. 3A and 3B show address mapping tables stored in a host device in accordance with embodiments of the present technology.

FIGS. 4A and 4B are flow diagrams illustrating routines for operating a memory device in accordance with embodiments of the present technology.

FIG. 5 is a schematic view of a system that includes a memory device in accordance with embodiments of the present technology.

### DETAILED DESCRIPTION

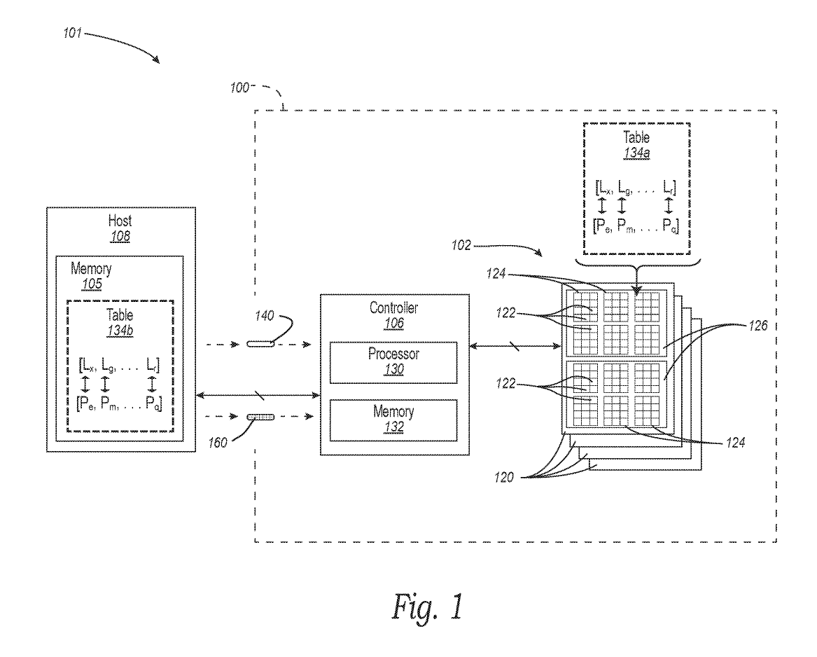

As described in greater detail below, the technology disclosed herein relates to memory devices, systems with memory devices, and related methods for enabling a host device to directly read from the memory of the memory device. A person skilled in the relevant art, however, will understand that the technology may have additional embodiments and that the technology may be practiced without several of the details of the embodiments described below with reference to FIGS. 1-5. In the illustrated embodiments below, the memory devices are described in the context of devices incorporating NAND-based storage media (e.g., NAND flash). Memory devices configured in accordance with other embodiments of the present technology, however, can include other types of suitable storage media in addition to or in lieu of NAND-based storage media, such as magnetic storage media.

FIG. 1 is a block diagram of a system 101 having a memory device 100 configured in accordance with an embodiment of the present technology. As shown, the memory device 100 includes a main memory 102 (e.g., NAND flash) and a controller 106 operably coupling the main memory 102 to a host device 108 (e.g., an upstream central processor (CPU)). In some embodiments described in greater detail below, the memory device 100 can include a NAND-based main memory 102, but omits other types of memory media, such as RAM media. For example, in some embodiments, such a device may omit NOR-based memory (e.g., NOR flash) and DRAM to reduce power requirements and/or manufacturing costs. In at least some of these embodiments, the memory device 100 can be configured as a UFS device or an eMMC.

In other embodiments, the memory device 100 can include additional memory, such as NOR memory. In one such embodiment, the memory device 100 can be configured as an SSD. In still further embodiments, the memory device 100 can employ magnetic media arranged in a shingled magnetic recording (SMR) topology.

The main memory 102 includes a plurality of memory regions, or memory units 120, which each include a plurality of memory cells 122. The memory cells 122 can include, for example, floating gate, ferroelectric, magnetoresitive, and/or other suitable storage elements configured to store data persistently or semi-persistently. The main memory 102 and/or the individual memory units 120 can also include other circuit components (not shown), such as multiplexers, decoders, buffers, read/write drivers, address registers, data out/data in registers, etc., for accessing and/or programming (e.g., writing) the memory cells 122 and other functionality, such as for processing information and/or communicating with the controller 106. In one embodiment, each of the memory units 120 can be formed from a semiconductor die and arranged with other memory unit dies in a single device package (not shown). In other embodiments, one or more of the memory units 120 can be co-located on a single die and/or distributed across multiple device packages.

The memory cells 122 can be arranged in groups or “memory pages” 124. The memory pages 124, in turn, can be grouped into larger groups or “memory blocks” 126. In other embodiments, the memory cells 122 can be arranged in different types of groups and/or hierarchies than shown in the illustrated embodiments. Further, while shown in the illustrated embodiments with a certain number of memory cells, pages, blocks, and units for purposes of illustration, in other embodiments, the number of cells, pages, blocks, and memory units can vary, and can be larger in scale than shown in the illustrated examples. For example, in some embodiments, the memory device 100 can include eight, ten, or more (e.g., 16, 32, 64, or more) memory units 120. In such embodiments, each memory unit 120 can include, e.g., 2¹¹ memory blocks 126, with each block 126 including, e.g., 2¹⁵ memory pages 124, and each memory page 124 within a block including, e.g., 2¹⁵ memory cells 122.

The controller 106 can be a microcontroller, special purpose logic circuitry (e.g., a field programmable gate array (FPGA), an application specific integrated circuit (ASIC), etc.), or other suitable processor. The controller 106 can include a processor 130 configured to execute instructions stored in memory. In the illustrated example, the memory of the controller 106 includes an embedded memory 132 configured to perform various processes, logic flows, and routines for controlling operation of the memory device 100, including managing the main memory 102 and handling communications between the memory device 100 and the host device 108. In some embodiments, the embedded memory 132 can include memory registers storing, e.g., memory pointers, fetched data, etc. The embedded memory 132 can also include read-only memory (ROM) for storing micro-code.

In operation, the controller 106 can directly write or otherwise program (e.g., erase) the various memory regions of the main memory 102 in a conventional manner, such as by writing to groups of pages 124 and/or memory blocks 126. The controller 106 accesses the memory regions using a native addressing scheme in which the memory regions are recognized based on their native or so-called “physical” memory addresses. In the illustrated examples, physical memory addresses are represented by the reference letter “P” (e.g., Pₑ, Pₘ, P_{q}, etc.). Each physical memory address includes a number of bits (not shown) that can correspond, for example, to a selected memory unit 120, a memory block 126 within the selected unit 120, and a particular memory page 124 in the selected block 126. In NAND-based memory, a write operation often includes programming the memory cells 122 in selected memory pages 124 with specific data values (e.g., a string of data bits having a value of either logic “0” or logic “1”). An erase operation is similar to a write operation, except that the erase operation re-programs an entire memory block 126 or multiple memory blocks 126 to the same data state (e.g., logic “0”).

The controller 106 communicates with the host device 108 over a host-device interface (not shown). In some embodiments, the host device 108 and the controller 106 can communicate over a serial interface, such as a serial attach SCSI (SAS), a serial AT attachment (ATA) interface, a peripheral component interconnect express (PCIe), or other suitable interface (e.g., a parallel interface). The host device 108 can send various requests (in the form of, e.g., a packet or stream of packets) to the controller 106. A conventional request 140 can include a command to write, erase, return information, and/or to perform a particular operation (e.g., a TRIM operation). When the request 140 is a write request, the request will further include a logical address that is implemented by the host device 108 according to a logical memory addressing scheme. In the illustrated examples, logical addresses are represented by the reference letter “L” (e.g., Lₓ, L_{g}, Lᵣ, etc.). The logical addresses have addressing conventions that may be unique to the host-device type and/or manufacturer. For example, the logical addresses may have a different number and/or arrangement of address bits than the physical memory addresses associated with the main memory 102.

The controller 106 translates the logical address in the request 140 into an appropriate physical memory address using a first mapping table 134a or similar data structure stored in the main memory 102. In some embodiments, translation occurs over a flash translation layer. Once the logical address has been translated into the appropriate physical memory address, the controller 106 accesses (e.g., writes) the memory region located at the translated address.

In one aspect of the technology, the host device 108 can also translate logical addresses into physical memory addresses using a second mapping table 134b or similar data structure stored in a local memory 105 (e.g., memory cache). In some embodiments, the second mapping table 134b can be identical or substantially identical to the first mapping table 134a. In use, the second mapping table 134b enables the host device 108 to perform a direct read request 160 (referred to herein as a “direct read request 160”), as opposed to a conventional read request sent from a host device to a memory device. As described below, a direct read request 160 includes a physical memory address in lieu of the logical address.

In one aspect of the technology, the controller 106 does not reference the first mapping table 134a during the direct read request 160. Accordingly, the direct read request 160 can minimize processing overhead because the controller 106 does not have to retrieve the first mapping table 134a stored in the main memory 102. In another aspect of the technology, the local memory 105 of the host device 108 can be DRAM or other memory having a faster access time than the NAND-based memory 102, which is limited by its serial interface, as discussed above. In a related aspect, the host device 108 can leverage the relatively faster access time of the local memory 105 to increase the read speed of the memory device 100.

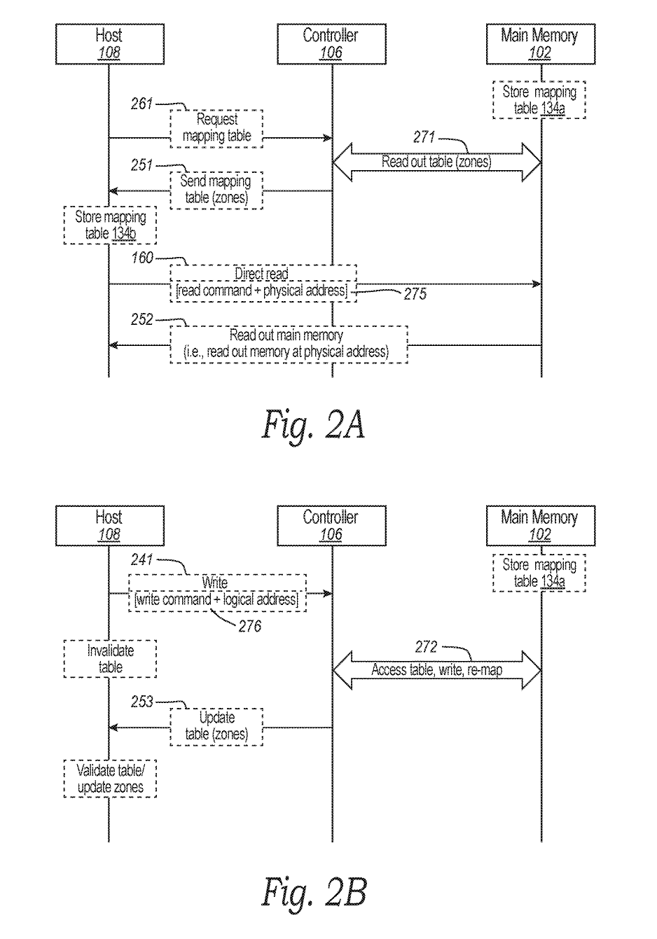

FIGS. 2A and 2B are message flow diagrams illustrating various data exchanges between the host device 108, the controller 106, and the main memory 102 of the memory device 100 (FIG. 1) in accordance with embodiments of the present technology.

FIG. 2A shows a message flow for performing a direct read. Before sending the direct read request 160, the host device 108 can send a request 261 for the first mapping table 134a stored in the main memory 102. In response to the request 261, the controller 106 sends a response 251 (e.g., a stream of packets) to the host device 108 that contains the first mapping table 134a.

In some embodiments, the controller 106 can retrieve the first mapping table 134a from the main memory 102 in a sequence of exchanges, represented by double-sided arrow 271. During the exchanges, a portion, or zone, of physical to logical address mappings is read out into the embedded memory 132 (FIG. 1) from the first mapping table 134a stored in the main memory 102. Each zone can correspond to a range of physical memory addresses associated with one or memory regions (e.g., a number of memory blocks 126; FIG. 1). Once a zone is read out into the embedded memory 132, the zone is subsequently transferred to the host device 108 as part of the response 251. The next zone in the first mapping table 134a is then read out and transferred to the host device 108 in a similar fashion. Accordingly, the zones can be transferred in a series of corresponding packets as part of the response 251. In one aspect of this embodiment, dividing and sending the first mapping table 134a in the form of zones can reduce occupied bandwidth.

The host device 108 constructs the second mapping table 134b based on the zones it receives in the response 251 from the controller 106. In some embodiments, the controller 106 may restrict or reserve certain zones for memory maintenance, such as OP space maintenance. In such embodiments, the restricted and/or reserved zones are not sent to the host device 108, and they do not form a portion of the second mapping table 134b stored by the host device 108.

The host device 108 stores the second mapping table 134b in local memory 105 (FIG. 1). The host device 108 also validates the second mapping table 134b. The host device 108 can periodically invalidate the second mapping table 134b when it needs to be updated (e.g., after a write operation). The host device 108 will not read from the memory using the second mapping table 134b when it is invalidated.

Once the host device 108 has validated the second mapping table 134b, the host device 108 can send the direct read request 160 to the main memory 102 using the second mapping table 134b. The direct read request 160 can include a payload field 275 that contains a read command and a physical memory address selected from the second mapping table 134b. The physical memory address corresponds to the memory region to be read from the main memory 102 and which has been selected by the host device 108 from the second mapping table 134b. In response to the direct read request 160, the content of the selected region of the memory 102 can be read out via the intermediary controller 106 in one or more read-out response 252 (e.g., read-out packets).

FIG. 2B shows a message flow for writing or otherwise programming (e.g., erasing) a region (e.g., a memory page) of the main memory 102 using a conventional write request 241. The write request 241 can include a payload field 276 that contains the logical address, a write command, and data to be written (not shown). The write request 241 can be sent after the host device 108 has stored the second mapping table 134b, as described above with reference to FIG. 2A. Even though the host device 108 does not use the second mapping table 134b to identify an address when writing to the main memory 102, the host device will invalidate this table 134b when it sends a write request. This is because the controller 106 will typically re-map at least a portion of the first mapping table 134a during a write operation, and invalidating the second mapping table 134b will prevent the host device 108 from using an outdated mapping table stored in its local memory 105 (FIG. 1).

When the controller 106 receives the write request 241, it first translates the logical address into the appropriate physical memory address. The controller 106 then writes the data of the request 241 to the main memory 102 in a conventional manner over a number of exchanges, represented by double-sided arrow 272. When the main memory 102 has been written (or re-written), the controller 106 updates the first mapping table 134a. During the update, the controller 106 will typically re-map at least a subset of the first mapping table 134a due to the serial nature in which data is written to NAND-based memory.

To re-validate the second mapping table 134b, the controller sends an update 253 to the host-device 108 with updated address mappings, and the host device 108 re-validates the second mapping table 134b. In the illustrated embodiment, the controller 106 sends to the host device 108 only the zones of the first mapping table 134a that have been affected by the re-mapping. This can conserve bandwidth and reduce processing overhead since the entire first mapping table 134a need not be re-sent to the host device 108.

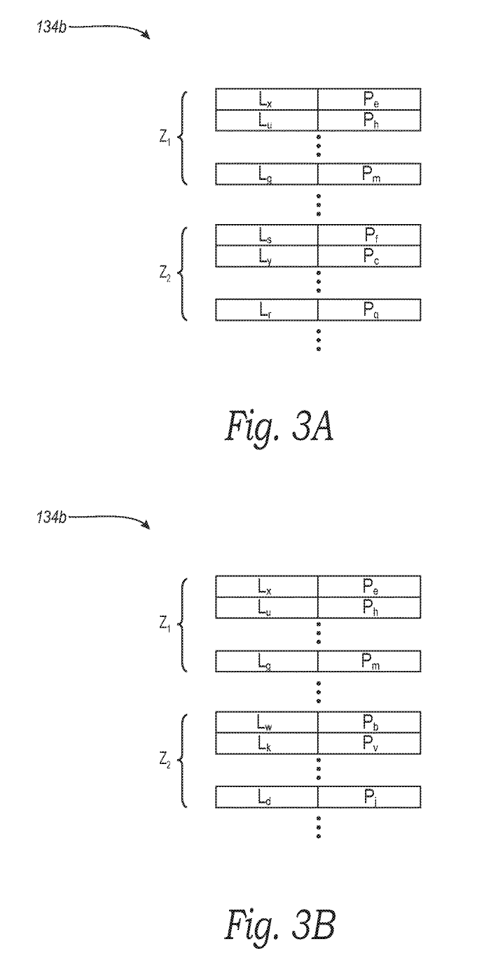

FIGS. 3A and 3B show a portion of the second mapping table 134b used by the host device 108 in FIG. 2B. FIG. 3A shows first and second zones Z₁ and Z₂, respectively, of the second mapping table 134b before it has been updated in FIG. 2B (i.e., before the controller 106 sends the update 253). FIG. 3B shows the second zone Z₂ being updated (i.e., after the controller 106 sends the update 253). The first zone Z₁ does not require an update because it was not affected by the re-mapping in FIG. 2B. Although only two zones are shown in FIGS. 3A and 3B for purposes of illustration, the first and second mapping tables 134a and 134a may include a greater number of zones. In some embodiments, the number of zones may depend on the size of the mapping table, the capacity of the main memory 102 (FIG. 1), and/or the number of pages 124, blocks 126, and/or units 120.

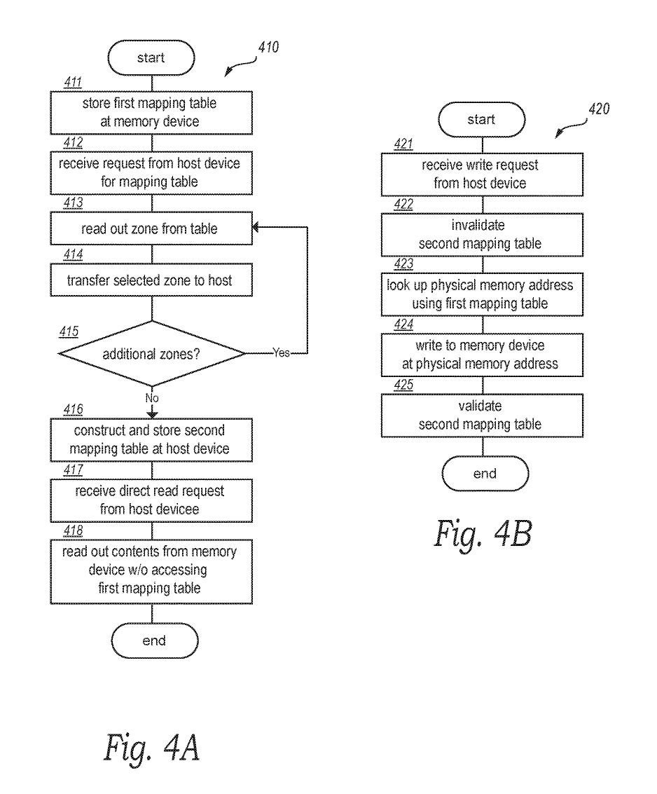

FIGS. 4A and 4B are flow diagrams illustrating routines 410 and 420, respectively, for operating a memory device in accordance with embodiments of the present technology. The routines 410, 420 can be executed, for example, by the controller 106 (FIG. 1), the host device 108 (FIG. 1), or a combination of the controller 106 and the host device 108 of the memory device 100 (FIG. 1). Referring to FIG. 4A, the routine 410 can be used to perform a direct read operation. The routine 410 begins by storing the first mapping table 134a at the memory device 100 (block 411), such as in one or more of the memory blocks 126 and/or memory units 120 shown in FIG. 1. The routine 410 can create the first mapping table 134a when the memory device 100 first starts up (e.g., when the memory device 100 and/or the host device 108 is powered from off to on). In some embodiments, the routine 410 can retrieve a previous mapping table stored in the memory device 100 at the time it was powered down, and validate this table before storing it at block 411 as the first mapping table 134a.

At block 412, the routine 410 receives a request for a mapping table. The request can include, for example, a message having a payload field that contains a unique command that the controller 106 recognizes as a request for a mapping table. In response to the request, the routine 410 sends the first mapping table 134a to the host device (blocks 413-415). In the illustrated example, the routine 410 sends portions (e.g., zones) of the mapping table to the host device 108 in a stream of responses (e.g., a stream of response packets). For example, the routine 410 can read out a first zone from the first mapping table 134a (block 413), transfer this zone to the host device 108 (block 414), and subsequently read out and transfer the next zone (block 415) until the entire mapping table 134a has been transferred to the host device 108. The second mapping table 134b is then constructed and stored at the host device 108 (block 416). In some embodiments, the routine 410 can send an entire mapping table at once to the host device 108 rather than sending the mapping table in separate zones.

At block 417, the routine 410 receives a direct read request from the host device 108, and proceeds to directly read from the main memory 102. The routine 410 uses the physical memory address contained in the direct read request to locate the appropriate memory region of the main memory 102 to read out to the host device 108, as described above. In some embodiments, the routine 410 can partially process (e.g., de-packetize or format) the direct read request into a lower-level device protocol of the main memory 102.

At block 418, the routine 410 reads out the main memory 102 without accessing the first mapping table 134a during the read operation. In some embodiments, the routine 410 can read out the content from a selected region of memory 102 into a memory register at the controller 106. In various embodiments, the routine 410 can partially process (e.g., packetize or format) the content for sending it over a transport layer protocol to the host device 108.

Referring to FIG. 4B, the routine 420 can be carried out to perform a programming operation, such as a write operation. At block 421, the routine 420 receives a write request from the host device 108. The routine 420 also invalidates the second mapping table 134b in response to the host device 108 sending the write request (block 422).

At block 423, the routine looks up a physical memory address in the first mapping table 134a using the logical address contained in the write request sent from the host device 108. The routine 424 then writes the data in the write request to the memory device 102 at the translated physical address (block 424).

At block 425, the routine 420 re-maps at least a portion of the first mapping table 134a in response to writing the main memory 102. The routine 420 then proceeds to re-validate the second mapping table 134b stored at the host device 108 (block 426). In the illustrated example, the routine 420 sends portions (e.g., zones) of the first mapping table 134a to the host device 108 that were affected by the re-mapping, but does not send the entire mapping table 134a. In other embodiments, however, the routine 420 can send the entire first mapping table 134a, such as in cases where the first mapping table 134a was extensively re-mapped.

In various embodiments, the routine 420 can re-map the first mapping table 134a in response to other requests sent from the host device, such as in response to a request to perform a TRIM operation (e.g., to increase operating speed). In these and other embodiments, the routine 420 can re-map portions of the first mapping table 134a without being prompted to do so by a request sent from the host device 108. For example, the routine 420 may re-map portions of the first mapping table 134a as part of a wear-levelling process. In such cases, the routine 420 may periodically send updates to the host device 108 with certain zones that were affected in the first mapping table 134a and that need to be updated.

Alternately, rather than automatically sending the updated zone(s) to the host device 108 (e.g., after a wear-levelling operation), the routine 420 may instruct the host device 108 to invalidate the second mapping table 134b. In response, the host device 108 can request an updated mapping table at that time or at a later time in order to re-validate the second mapping table 134b. In some embodiments the notification enables the host device 108 to schedule the update rather than timing of the update being dictated by the memory device 100.

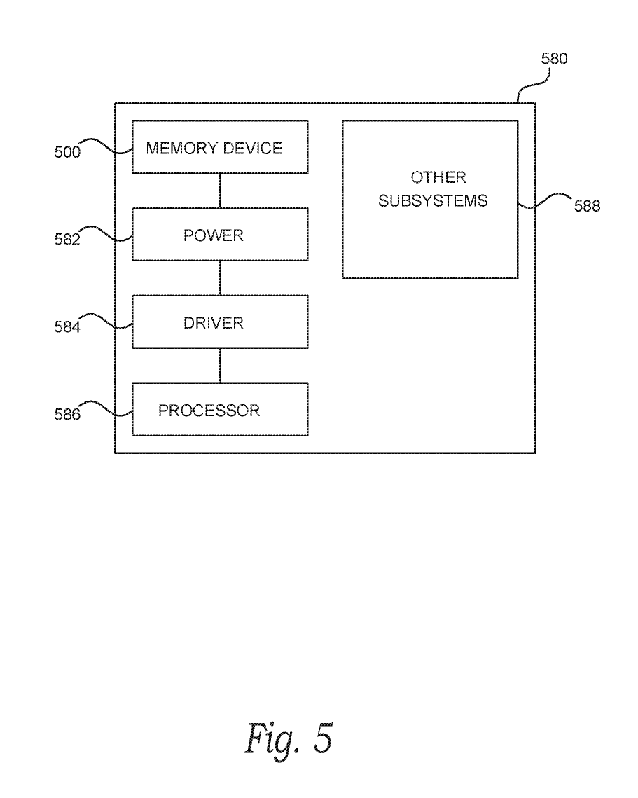

FIG. 5 is a schematic view of a system that includes a memory device in accordance with embodiments of the present technology. Any one of the foregoing memory devices described above with reference to FIGS. 1-4B can be incorporated into any of a myriad of larger and/or more complex systems, a representative example of which is system 580 shown schematically in FIG. 5. The system 580 can include a memory device 500, a power source 582, a driver 584, a processor 586, and/or other subsystems or components 588. The memory device 500 can include features generally similar to those of the memory device described above with reference to FIGS. 1-4, and can therefore include various features for performing a direct read request from a host device. The resulting system 580 can perform any of a wide variety of functions, such as memory storage, data processing, and/or other suitable functions. Accordingly, representative systems 580 can include, without limitation, hand-held devices (e.g., mobile phones, tablets, digital readers, and digital audio players), computers, vehicles, appliances and other products. Components of the system 580 may be housed in a single unit or distributed over multiple, interconnected units (e.g., through a communications network). The components of the system 580 can also include remote devices and any of a wide variety of computer readable media.

From the foregoing, it will be appreciated that specific embodiments of the technology have been described herein for purposes of illustration, but that various modifications may be made without deviating from the disclosure. In addition, certain aspects of the new technology described in the context of particular embodiments may also be combined or eliminated in other embodiments. Moreover, although advantages associated with certain embodiments of the new technology have been described in the context of those embodiments, other embodiments may also exhibit such advantages and not all embodiments need necessarily exhibit such advantages to fall within the scope of the technology. Accordingly, the disclosure and associated technology can encompass other embodiments not expressly shown or described herein.

I/We claim:

1. A memory device, comprising:
a memory having a plurality of memory regions assigned to corresponding first memory addresses; and
a controller operably coupled to the memory, wherein the controller is configured to—
store a first mapping table at the memory device, wherein the first mapping table maps the first memory addresses to second memory addresses implemented by a host device to write to the memory regions,
provide the first mapping table to the host device for storage at the host device as a second mapping table, wherein the second mapping table maps the first memory addresses to the second memory addresses,
receive a read request sent from the host device, wherein the read request includes a first memory address selected by the host device from the second mapping table stored at the host device, and
in response to the read request, (1) identify one of the memory regions using the first memory address in the read request and without looking up the first memory address in the first mapping table and (2) read out content of the identified memory region to the host device.

2. The memory device of claim 1 wherein the controller is further configured to:
receive a write request from the host device, the write request including a second memory address selected by the host device from the second mapping table; and
in response to the write request, identify and write to a memory region using the first mapping table to translate the second memory address in the write request.

3. The memory device of claim 2 wherein the controller is further configured to:
re-map the first mapping table in response to the write request; and
send an update to the host device, wherein the update includes at least a portion of the first mapping table that has been re-mapped.

4. The memory device of claim 1 wherein the controller is further configured to re-map the first mapping table and notify the host device that the first mapping table has been re-mapped.

5. The memory device of claim 4 wherein the controller is further configured to send an update to the host device, wherein the update includes at least a portion of the first mapping table that has been re-mapped.

6. The memory device of claim 1 wherein the controller is further configured to re-map the first mapping table and send an update to the host device, wherein the update includes a portion of the first mapping table that has been re-mapped, but not the entire mapping table.

7. The memory device of claim 1 wherein the controller is further configured to store the first mapping table in one or more of the memory regions of the memory.

8. The memory device of claim 7 wherein the memory regions comprise NAND-flash memory media.

9. The memory device of claim 1 wherein the controller includes an embedded memory, and wherein the controller is further configured to:
read out a first portion of the mapping table from the one or more memory regions into the embedded memory;
transfer the first portion of the mapping table to the host device from the embedded memory;
read out a second portion of the first mapping table from the one or more regions into the embedded memory once the first portion of the first mapping table has been transferred to the host device; and
transfer the second portion of the mapping table to the host device from the embedded memory.

10. The memory device of claim 1 wherein the controller is further configured to:
receive a request for the first mapping table from the host device; and
send the first mapping table to the host device in response to the request for the first mapping table.

11. The memory device of claim 1 wherein the controller is further configured to:
receive a request for the first mapping table from the host device; and
in response to the request for the mapping table, (1) send a first portion of the first mapping table in a first response and (2) send a second portion of the second mapping table in a second response such that the host device can construct the second mapping table using the first and second portions of the mapping table.

12. A method of operating a memory device having a controller and a plurality of memory regions, wherein the memory regions have corresponding native memory addresses implemented by the controller to read and write to the memory regions, and wherein the method comprises:
mapping the native memory addresses to logical addresses implemented by a host device when writing to the memory device;
storing the mapping in a first mapping table at the memory device;
providing the first mapping table to the host device for storing the first mapping table as a second mapping table at the host device;
receiving a read request from the host device, wherein the read request includes a native memory address selected by the host device from the second mapping table stored at the host device; and
reading out content to the host device from one of the memory regions corresponding to the native memory address selected by the host device.

13. The method of claim 12, further comprising:
re-mapping native memory addresses to different logical addresses;
updating a portion of the first mapping table to reflect the re-mapping; and
providing the updated portion of the first mapping table to the host device.

14. The method of claim 12, further comprising invalidating the second mapping table before the re-mapping.

15. The method of claim 12 wherein the re-mapping is part of a wear-levelling process conducted by the memory device.

16. The method of claim 12, further comprising:
receiving a write request;
updating separate portions of the first mapping table in response to the write request; and
providing the updated portions of the first mapping table, but not the entire first mapping table, to the host device.

17. A system, comprising:
a memory device having a plurality of memory regions with corresponding first memory addresses, and wherein the memory device is configured to store a first mapping table that includes a mapping of the first memory addresses to second memory addresses; and
a host device operably coupled to the memory device and having a memory, wherein the host device is configured to—
write to the memory device via the first mapping table stored at the memory device,
store a second mapping table in the memory of the host device that includes the mapping of the first mapping table, and
read from the memory device via the second mapping table in lieu of the first mapping table.

18. The system of claim 17 wherein the memory device is further configured to update a portion of the first mapping table, and wherein the host device is further configured to receive the updated portion of the first mapping table, and update the second mapping table based on the updated portion of the first mapping table.

19. The system of claim 18 wherein the memory device is further configured to instruct the host device to validate the second mapping table in response to the update.

20. The system of claim 18 wherein the host device is further configured to invalidate the second mapping table when writing to the memory device.

21. The system of claim 17 wherein the host device is further configured to request the first mapping table from the memory device.

22. The system of claim 17 wherein the memory device is further configured to transfer individual portions of the first mapping table to the host device, and wherein the host device is further configured to construct the second mapping table from the individual portions transferred to the host device.

23. The system of claim 17 wherein the memory regions of the memory device are NAND-based memory regions, and wherein the memory of the host device is a random access memory.

24. The system of claim 23 wherein the memory device is further configured to store the first mapping table in one or more of the memory regions.
